(19) United States
(12) Patent Application Publication
(10) Pub. No.: US 2011/0132512 A1
(43) Pub. Date: Jun. 9, 2011

(54) RUBBER COMPOSITION FOR COATING STEEL CORD

(75) Inventor: Naoki Inui, Yamatokoriayama-shi (JP)

(73) Assignee: SUMITOMO CHEMICAL COMPANY, LIMITED, Tokyo (JP)

(21) Appl. No.: 12/994,395

(22) PCT Filed: Jun. 2, 2009
(86) PCT No.: PCT/JP2009/060415

§ 371 Date: Jan. 6, 2011

(30) Foreign Application Priority Data
Jun. 11, 2008 (JP) 2008-152615

(51) Int. Cl. B60C 9/00; C08K 5/1545; D02G 3/00

(52) U.S. Cl. 152/451; 524/110; 428/396

(57) ABSTRACT

A rubber composition for coating a steel cord comprising:
(A) 100 parts by weight of a rubber component mainly containing at least one rubber selected from the group consisting of natural rubbers, styrene-butadiene copolymerized rubbers and butadiene rubbers,
(B) 0.5 to 3 parts by weight of a condensation composition containing a condensation product of resorcin and acetone, which contains 40 to 80% by weight of 2,2,4-trimethyl-2′,4′,7′-trihydroxyflavan and 0 to 0.2% by weight of an acid or an alkali metal salt thereof per the total weight of the condensation composition,
(C) 0.1 to 0.4 part by weight of an organic cobalt compound in terms of cobalt content, and
(D) 0.5 to 2 parts by weight of a methoxylated methylolmelamine resin.

### FIELD OF THE INVENTION

The present invention relates to a rubber composition for coating a steel cord.

### BACKGROUND ARTS

JP H9-87425 A1 discloses a rubber composition comprising a condensation product which is obtained by a condensation reaction of resorcin and acetone using p-toluenesulfonic acid monohydrate as an acid and sodium hydroxide as a neutralizing agent and which contains 2,4,4-trimethyl-2′,4′,7-trihydroxyflavan of 70.7% or 34.1%, a vulcanizable natural rubber and hexamethylenetetramine.

### DISCLOSURE OF THE INVENTION

The present invention provides:

<1> A rubber composition for coating a steel cord comprising:
(A) 100 parts by weight of a rubber component mainly containing at least one rubber selected from the group consisting of natural rubbers, styrene-butadiene copolymerized rubbers and butadiene rubbers,
(B) 0.5 to 3 parts by weight of a condensation composition containing a condensation product of resorcin and acetone, which contains 40 to 80% by weight of 2,2,4-trimethyl-2′,4′,7′-trihydroxyflavan and 0 to 0.2% by weight of an acid or an alkali metal salt thereof per the total weight of the condensation composition,
(C) 0.1 to 0.4 part by weight of an organic cobalt compound in terms of cobalt content, and
(D) 0.5 to 2 parts by weight of a methoxylated methylolmelamine resin;
   <2> The rubber composition for coating a steel cord according to <1>, which further contains a vulcanization accelerator;
   <3> The rubber composition for coating a steel cord according to <2>, wherein the vulcanization accelerator is N,N-dicyclohexyl-2-benzothiazolesulfenamide;
   <4> The rubber composition for coating a steel cord according to any of <1> to <3>, which does not contain N-cyclohexyl-2-benzothiazolesulfenamide;
   <5> The rubber composition for coating a steel cord according to any of <1> to <4>, which does not contain hexamethylenetetramine;
   <6> The rubber composition for coating a steel cord according to any of <1> to <5>, which further contains 45 to 60 parts by weight of carbon black per 100 parts by weight of the rubber component (A);
   <7> The rubber composition for coating a steel cord according to any of <1> to <6>, which further contains 5 to 15 parts by weight of hydrous silica per 100 parts by weight of the rubber component (A);
   <8> A belt comprising a steel cord coated with the rubber composition for coating a steel cord according to any of <1> to <7>;
   <9> A pneumatic tire produced by using the rubber composition for coating a steel cord according to any of <1> to <7>;
   <10> Use of the rubber composition for coating a steel cord according to any of <1> to <7> for producing a steel cord coated with a rubber composition;
   <11> A process for producing a belt comprising a steel cord coated with a rubber composition which comprises coating a steel cord with the rubber composition for coating a steel cord according to any of <1> to <7>;
   <12> Use of the rubber composition for coating a steel cord according to any of <1> to <7> for producing a pneumatic tire.

### BEST MODES FOR CARRYING OUT THE INVENTION

The rubber composition for coating a steel cord of the present invention comprises
(A) 100 parts by weight of a rubber component mainly containing at least one rubber selected from the group consisting of natural rubbers, styrene-butadiene copolymerized rubbers and butadiene rubbers (hereinafter, simply referred to as Component A),
(B) 0.5 to 3 parts by weight of a condensation composition containing a condensation product of resorcin and acetone, which contains 40 to 80% by weight of 2,2,4-trimethyl-2′,4′,7′-trihydroxyflavan and 0 to 0.2% by weight of an acid or an alkali metal salt thereof per the total weight of the condensation composition (hereinafter, simply referred to as Component B),
(C) 0.1 to 0.4 part by weight of an organic cobalt compound in terms of cobalt content (hereinafter, simply referred to as Component C), and
(D) 0.5 to 2 parts by weight of a methoxylated methylolmelamine resin (hereinafter, simply referred to as Component D).

Examples of Component A include those containing at least one rubber selected from the group consisting of natural rubbers, styrene-butadiene copolymerized rubbers and butadiene rubbers in 50% by weight or more. Component A may contain rubber components other than at least one rubber selected from the group consisting of natural rubbers, styrene-butadiene copolymerized rubbers and butadiene rubbers, and specific examples of the rubber component other than the above-mentioned rubber include isoprene rubber. Especially, a rubber component containing natural rubbers in 50% by weight or more is preferable from the viewpoint of dynamic viscoelasticity, tear strength and low heat build-up, and a rubber component consisting of natural rubbers is more preferable.

As natural rubbers, styrene-butadiene copolymerized rubbers and butadiene rubbers, commercially available one may be used, and one produced according to known methods may be used. As the rubber component other than the above-mentioned rubber, commercially available one may be used, and one produced according to known methods may be used.

Component B is a condensation composition containing a condensation product of resorcin and acetone, and contains 40 to 80% by weight of 2,2,4-trimethyl-2′,4′,7′-trihydroxyflavan represented by the following formula:

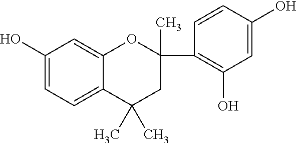

and 0 to 0.2% by weight of an acid or an alkali metal salt thereof per the total weight of the condensation composition.

Component B thus can be produced, for example, by condensing resorcin with acetone in the presence of an acid catalyst in a water-nonmiscible organic solvent followed by, as necessary, neutralizing the reaction mixture with an alkali metal base, filtrating, washing and drying the solid matters generated.

The acid catalyst used in the condensation reaction of resorcin and acetone may be an acidic material, and examples thereof include sulfuric acid, p-toluenesulfonic acid, hydrochloric acid and phosphoric acid. The acid catalyst may be used as it is and may be used as an aqueous solution having a suitable concentration. While the amount of the acid catalyst to be used is not limited, it is preferably 0.1 to 10% by mole per 1 mole of resorcin and more preferably 0.5 to 5% by mole.

Examples of the water-nonmiscible organic solvent include aliphatic hydrocarbons such as hexane, heptane, octane and decane, aromatic hydrocarbons such as toluene, xylene and ethylbenzene, and aromatic halogen-substituted hydrocarbons such as chlorobenzene and dichlorobenzene. Among them, preferred are aromatic hydrocarbons, and more preferred are toluene and xylene. The amount of the organic solvent to be used is preferably 1 to 3 parts by weight per 1 part by weight of resorcin. The amount of resorcin to be used is preferably 0.6 to 1.5 moles per 1 mole of acetone and more preferably 0.8 to 1.3 moles.

The condensation reaction is preferably conducted by adding 2,2,4-trimethyl-2′,4′,7′-trihydroxyflavan into the reaction system from the beginning of the condensation reaction. The amount of 2,2,4-trimethyl-2′,4′,7′-trihydroxyflavan to be used is preferably 0.5 to 10% by mole per 1 mole per resorcin.

The content of 2,2,4-trimethyl-2′,4′,7′-trihydroxyflavan in Component B can be adjusted by arbitrarily adjusting the kind of an acid catalyst, the amount of an acid catalyst to be used, the amount of acetone to be used and the amount of 2,2,4-trimethyl-2′,4′,7′-trihydroxyflavan to be used.

While the reaction temperature is not limited, it is usually in a range of 30° C. to a reflux temperature.

Component B can be obtained by, as necessary, neutralizing the reaction mixture obtained with an alkali metal base of which amount is an equal to normal amount of the acid catalyst used, filtrating to obtain solid matters, further washing the solid matters with water followed by drying. When the alkali metal salt generated by neutralization is not removed by washing or when the reaction is conducted using a lower-volatile acid catalyst followed by not conducting neutralization or washing, the solid matters in which a lot of the acid used or an alkali metal salt thereof remains is obtained, and using the solid matters in which a lot of the acid used or an alkali metal salt thereof remains as Component B is not preferable because of giving adverse effects to the desired various properties of the present invention. Alternatively, when the solvent is distilled away as it is after neutralization, the solid matters in which a lot of the acid or a salt thereof remains is also obtained, and using the solid matters as Component B is not preferable because of giving adverse effects to the desired various properties of the present invention.

The amount of Component B to be blended is 0.5 to 3 parts by weight per 100 parts of Component A, and preferably 1 to 2 parts by weight.

The amount of Component C to be blended is 0.1 to 0.4 part by weight in terms of cobalt content per 100 parts of Component A, and preferably 0.1 to 0.3 part by weight. Examples of the organic cobalt compound include acid cobalt salts such as cobalt naphthenate and cobalt stearate, and an aliphatic acid. boron complex compound (for example, product name “MANOBOND C” manufactured by Manchem. Co., Ltd.). As Component C, commercially available one is usually used.

Examples of Component D include those usually used in the rubber industry such as hexakis (methoxymethyl) melamine, pentakis (methoxymethyl)methylolmelamine and tetrakis(methoxymethyl)dimethylolmelamine. These may be used alone or two or more kinds thereof may be used in combination. Among them, preferred is hexakis (methoxymethyl)melamine alone or a mixture containing a lot of hexakis (methoxymethyl)melamine. The amount of Component D to be blended is 0.5 to 2 parts by weight per 100 parts of Component A, and preferably 1 to 2 parts by weight.

Component D is produced, for example, by a methylol step of conducting a condensation reaction in the presence of an acid catalyst such as sulfuric acid, p-toluenesulfonic acid and hydrochloric acid by mixing 4 to 9 moles of methanol and 8 to 11 moles of paraformaldehyde to 1 mole of melamine to obtain a methylolmelamine resin, and conducting a condensation reaction in the presence of an acid catalyst such as sulfuric acid, p-toluenesulfonic acid and hydrochloric acid by mixing the methylolmelamine resin obtained with 8 to 25 moles of methanol per 1 mole of melamine used in the previous step.

The rubber composition for coating a steel cord of the present invention can further contain reinforcing agents and/or fillers, as necessary. As the reinforcing agents and fillers, those usually used in rubber industry can be used. Specific examples thereof include reinforcing agents such as carbon black, and inorganic fillers such as silica, clay and calcium carbonate. Among them, preferred is blending of carbon black from the viewpoint of reinforcibility, and those usually used in rubber industry, for example, SAF, ISAF, HAF, FEF, SRF, GPF and MT, can be used. Especially, from the viewpoint of heat build-up, HAF, FEF and SRF are preferably used. The amount of the reinforcing agents and/or fillers, especially carbon black, to be blended is preferably in the range of about 10 to 80 parts by weight per 100 parts by weight of Component A from the viewpoint of heat build-up, and is more preferably in the range of about 45 to 60 parts by weight.

The rubber composition for coating a steel cord of the present invention preferably also contains hydrous silica aside from carbon black or together with carbon black. When hydrous silica is used, the amount of hydrous silica to be blended is preferably in the range of 5 to 15 parts by weight per 100 parts by weight of Component A.

The rubber composition for coating a steel cord of the present invention may contain one or more kinds of various rubber chemicals usually used in the rubber industry, for example, age resisters such as antioxidants and antiozonants, vulcanization agents, cross-linking agents, vulcanization accelerators, retarders, peptizers, processing aids, waxes, oils, stearic acid and tackifiers, as necessary. These rubber chemicals can be used in an amount of the range in which they each are usually used in the rubber industry. As the vulcanization accelerator, N,N-dicyclohexyl-2-benzothiazolesulfenamide is preferably used from the viewpoint of adhesiveness to a steel cord, and it is preferred that the composition does not contain N-cyclohexyl-2-benzothiazolesulfenamide. Alternatively, it is preferred that the rubber composition for coating a steel cord of the present invention does not contain hexamethylenetetramine.

The belt of the present invention can be produced by coating steel cords with the rubber composition for coating a steel cord of the present invention. The steel cords are usually used in the form of being parallel aligned by pulling.

It is preferred that steel cords are plated with brass, zinc or alloy containing it and nickel or cobalt from the viewpoint of adhesiveness to a rubber, and those plated with brass are especially preferable. Especially, steel cords plated with brass wherein the content of Cu in the brass-plating is 75% by mass or less, and preferably 55 to 70% by mass are preferable. The twist structure of steel cords is not limited.

The plural belts of the present invention may be layered to be used. The belts of the present invention are used as belt members, reinforcing members of bead portions, reinforcing members of side portions and tire reinforcing materials such as carcass.

The pneumatic tire of the present invention is produced by using the rubber composition for coating a steel cord of the present invention according to conventional process for producing a pneumatic tire. For example, steel cords are coated with the rubber composition for coating a steel cord of the present invention to obtain a belt and the belt is applied and molded to other tire member or members such as members for tread on a tire molding machine according to a conventional method to be molded to an unvulcanized tire. This unvulcanized tire is heated and pressurized in a vulcanizer to obtain a tire.

### EXAMPLES

The present invention will be illustrated in more detail by Examples bellow, but the present invention is not limited to these Examples.

### Reference Example 1

### Production of Component B

Into a 200 mL four-necked flask equipped with a thermometer, a stirrer and a condenser, 37.9 g of resorcin was added. After substituting to nitrogen in the flask, 21.9 g of acetone and 70.0 g of toluene were added thereto. The obtained mixture was heated up to 40° C. to perfectly dissolve resorcin. To the obtained solution, 1.0 g of 2,4,4-trimethyl-2′,4′,7-trihydroxyflavan was added thereto. Further, 655 mg of p-toluenesulfonic acid monohydrate was added thereto, and the obtained mixture was refluxed at an inner temperature of 88° C. for 8 hours. After completion of the reaction, the reaction mixture was cooled down to room temperature, and then, the solid matters precipitated were filtrated. The solid matters obtained were washed twice with 52 g of water. The solid matters obtained were dried at 50° C. and 10 mmHg for 8 hours to obtain a 39.7 g of a condensation composition containing a semicrystalline condensation product of resorcin and acetone (hereinafter, simply referred to as B1). B1 was analyzed with chromatography to calculate the contents of each component. The results are shown below.

2,4,4-trimethyl-2′,4′,7-trihydroxyflavan: 54.1% by weight
resorcin: 4.0% by weight
p-toluenesulfonic acid: 0.1% by weight

### Reference Example 2

### Production of Component B

Into a 200 mL four-necked flask equipped with a thermometer, a stirrer and a condenser, 37.9 g of resorcin was added. After substituting to nitrogen in the flask, 21.9 g of acetone and 69.0 g of toluene were added thereto. The obtained mixture was heated up to 40° C. to perfectly dissolve resorcin. The obtained solution was heated up to 75° C., and then, 5.1 g of 2,4,4-trimethyl-2′,4′,7-trihydroxyflavan was added thereto. Further, 0.33 g of 96% sulfuric acid was added thereto, and the obtained mixture was kept at an inner temperature of 76 to 78° C. for 11 hours. After completion of the reaction, the reaction mixture was cooled down to room temperature, and the solid matters precipitated were filtrated. The solid matters obtained were washed twice with 50 g of water. The semicrystalline solid matters obtained were dried at 50° C. and 10 mmHg for 8 hours to obtain a condensation composition containing a condensation product of resorcin and acetone (hereinafter, simply referred to as B2). The melting point of B2 was analyzed to find that starting of melting was 121° C. and ending of melting was 134° C. B2 was analyzed with chromatography to calculate the contents of each component. The results are shown below. 2,4,4-trimethyl-2′,4′,7-trihydroxyflavan: 76.1% by weight resorcin: 0.5% by weight p-toluenesulfonic acid: 0.1% by weight or less

### Comparative Reference Example 1

### Production of Condensation Composition used in Comparative Example 1

Into a 200 mL four-necked flask equipped with a thermometer, a stirrer and a condenser, 33.2 g of resorcin was added. After substituting to nitrogen in the flask, 87.5 g of acetone was added thereto. The obtained mixture was heated up to 40° C. to perfectly dissolve resorcin. To the obtained solution, 5.73 g of p-toluenesulfonic acid was added and the mixture obtained was kept at an inner temperature of 65° C. for 13 hours. After completion of the reaction, the reaction mixture was cooled down to room temperature, and was neutralized with 30% aqueous sodium hydroxide solution. The solid matters obtained were filtrated. The solid matters were washed twice with 50 g of water. The solid matters obtained were dried at 50° C. and 10 mmHg for hours to obtain a condensation composition containing a condensation product of resorcin and acetone (hereinafter, simply referred to as B3). B3 was analyzed with chromatography to calculate the contents of each component. The results are shown below.

2,4,4-trimethyl-2′,4′,7-trihydroxyflavan: 2.3% by weight
resorcin: 0.1% by weight or less
sodium p-toluenesulfonate: 0.1% by weight

### Comparative Reference Example 2

### Production of Condensation Composition Used in Comparative Example 2

Into a 500 mL four-necked flask equipped with a thermometer, a stirrer and a condenser, 100.5 g of resorcin was added. After substituting to nitrogen in the flask, 53.0 g of acetone was added thereto. The obtained mixture was heated up to 40° C. to perfectly dissolve resorcin. To the obtained solution, 39.5 g of 32% by weight hydrochloric acid and 87.0 g of water were added and the mixture obtained was kept at an inner temperature of 45° C. for 8 hours. After completion of the reaction, the reaction mixture was cooled down to room temperature. The solid matters obtained were filtrated. The solid matters were washed with 50 g of water. The solid matters obtained were dried at 50° C. and 10 mmHg for 8 hours to obtain a condensation composition containing a condensation product of resorcin and acetone (hereinafter, simply referred to as B4). B4 was analyzed with chromatography to calculate the contents of each component.

The results are shown below.

2,4,4-trimethyl-2′,4′,7-trihydroxyflavan: 31.6% by weight
resorcin: 2.2% by weight
hydrochloric acid: 0.1% by weight or less

### Comparative Reference Example 3

### Production of Condensation Composition Used in Comparative Example 3

Into a 500 mL four-necked flask equipped with a thermometer, a stirrer and a condenser, 199.7 g of resorcin was added. After substituting to nitrogen in the flask, 202.1 g of acetone was added thereto. The obtained mixture was heated up to 40° C. to perfectly dissolve resorcin. To the obtained solution, 1.33 g of p-toluenesulfonic acid monohydrate was added and the mixture obtained was kept at an inner temperature of 78° C. for 3.5 hours. After completion of the reaction, the reaction mixture was cooled down to room temperature, and was neutralized with 30% aqueous sodium hydroxide solution. The mixture obtained was gradually heated at 20 mmHg until 60° C. to remove a distillate thereby obtaining 342 g of a condensation composition containing a condensation product of resorcin and acetone (hereinafter, simply referred to as B5). The melting point of B5 was analyzed to find that ending of melting was 140° C. B5 was analyzed with chromatography to calculate the contents of each component. The results are shown below.

2,4,4-trimethyl-2′,4′,7-trihydroxyflavan: 35.2% by weight
resorcin: 4.6% by weight
sodium p-toluenesulfonate: 0.4% by weight

### Comparative Reference Example 4

### Production of Condensation Composition Used in Comparative Example 4

Into a 300 mL four-necked flask equipped with a thermometer, a stirrer and a condenser, 86.0 g of resorcin was added. After substituting to nitrogen in the flask, 49.8 g of acetone was added thereto. The obtained mixture was heated up to 35° C. to perfectly dissolve resorcin. To the obtained solution, 1.64 g of p-toluenesulfonic acid monohydrate was added and the mixture obtained was heated up to 92° C. over 3 hours and kept at the same temperature for 3 hours. After completion of the reaction, the reaction mixture was cooled down to room temperature, and was neutralized with 30% aqueous sodium hydroxide solution. The mixture obtained was gradually heated at 50 mmHg until 120° C. to remove a distillate thereby obtaining 118 g of a condensation composition containing a condensation product of resorcin and acetone (hereinafter, simply referred to as B6). B6 was analyzed with chromatography to calculate the contents of each component. The results are shown below.

2,4,4-trimethyl-2′,4′,7-trihydroxyflavan: 69.5% by weight
resorcin: 0.5% by weight
sodium p-toluenesulfonate: 1.3% by weight

### Comparative Reference Example 5

### Production of Condensation Composition used in Comparative Example 5

Into a 500 mL four-necked flask equipped with a thermometer, a stirrer and a condenser, 110.0 g of resorcin was added. After substituting to nitrogen in the flask, 100 g of water was added thereto to perfectly dissolve resorcin. To the obtained solution, 10 mL of concentrated hydrochloric acid was added and the mixture obtained was kept at room temperature for 14 hours. After completion of the reaction, the solid matters precipitated were filtrated from the reaction mixture, and was washed with 50 g of water. The solid matters obtained was dried at 50° C. and 10 mmHg for 8 hours to obtain 64.2 g of a condensation composition containing a condensation product of resorcin and acetone (hereinafter, simply referred to as B7). B7 was analyzed with chromatography to calculate the contents of each component. The results are shown below.

2,4,4-trimethyl-2′,4′,7-trihydroxyflavan: 85.1% by weight
resorcin: 1.0% by weight
hydrochloric acid: 0.1% by weight or less

### Comparative Reference Example 6

### Production of Condensation Composition Used in Comparative Example 6

The recrystallization of the condensation composition obtained in Comparative Reference Example 5 was conducted using a mixed solvent of methanol and xylene to obtain a condensation composition containing a condensation product of resorcin and acetone (hereinafter, simply referred to as B8). B8 was analyzed with chromatography to calculate the contents of each component. The results are shown below.

2,4,4-trimethyl-2′,4′,7-trihydroxyflavan: 99.6% by weight
resorcin: 0.1% by weight or less
hydrochloric acid: 0.1% by weight or less

### Examples 1 to 2 and Comparative Examples 1 to 6

A 600 mL Laboplastomill manufactured by Toyo Seiki Seisakusho was used as a Banbury mixer and the initial temperature in the system was set at 150° C. 100 parts by weight of natural rubber (RSS#3) as Component A, 60 parts by weight of N330 carbon black, 2 parts by weight of stearic acid, 8 parts by weight of zinc oxide, 1 part by weight of N-phenyl-N′-1,3-dimethylbutyl-p-phenylenediamine and 2 parts by weight of 2,2,4-trimethyl-1,2-dihydroquinoline polymer as age resisters and 1.5 parts by weight of the condensation compositions containing a condensation product of resorcin and acetone B1 to B8 obtained in the above-mentioned Reference Examples 1 to 2 and the above-mentioned comparative Reference Examples 1 to 6 as Component B were added into the mixer followed by kneading at 50 rpm for 15 minutes to obtain a rubber composition. The rubber temperature at that time was about 160° C.

Next, the rubber composition obtained was added into an open mill, and 4 parts by weight of sulfur, 0.8 part by weight of N,N-dicylohexyl-2-benzothiazolesulfenamide as a vulcanization accelerator, 2 parts by weight of cobalt naphthenate (content of cobalt: 11%) as Component C and 3 parts by weight of a methoxylated methylolmelamine resin (Sumikanol 507 manufactured by Sumitomo Chemical Co., Ltd., content of the active components: 50% by weight) as Component D were added thereto at a rubber temperature of 50 to 70° C. followed by conducting kneading to obtain a rubber composition for coating a steel cord.

The various test pieces were prepared using the rubber compositions obtained and vulcanized at 150° C. for 30 minutes to obtain the vulcanized rubber composition for coating a steel cord.

The tests for measuring dynamic viscoelasticity, tear strength, heat build-up and dispersibility in the rubber were carried out using the rubber compositions obtained, respectively. Each of tests was conducted according to the following methods, and the results thereof are shown in Table 1.

### <Dynamic Viscoelasticity Test>

The dynamic modulus of elasticity E′ at 20° C. was measured at the initial strain of 10%, the dynamic strain of 0.5% and the frequency of 10 Hz using a dynamic viscoelasticity spectrometer F-III manufactured by Iwamoto Seisakusho Co., Ltd. The higher the dynamic modulus of elasticity is, the higher rigidity the rubber composition has, and therefore, it is preferred.

### <Tear Strength Test>

According to JIS K-6301, a B-type test piece was prepared, and the average value of six measuring was made to the measured value. The bigger the value is, the stronger the strength of the rubber composition is, and therefore, it is preferred.

### <Heat Build-Up Test>

Using a Goodrich flexometer, a cylindrical test piece having a diameter of 10 mm and a height of 20 mm was prepared and the temperature of the rubber test piece after 40-minute measurement at an internal temperature of 40° C., a load of 251 bs, a stroke of 6.35 mm and a revolution of 1800 rpm was measured, and the difference between it and the initial rubber temperature was made to the measured value. The smaller the difference is, the smaller the heat build-up of the rubber composition, and therefore, it is preferred.

### <Dispersibility Test in the Rubber>

The appearance of the test piece and the dispersion state of Component B inside thereof were observed with visual contact. When the dispersibility is bad, a lot of white subtle spots caused by Component B are observed on the surface of the rubber and inside thereof.

TABLE 1

| | | Dynamic | | | |
|---|---|---|---|---|---|
| | | modulus of | Tear | Heat | |
| | Condensation | elasticity E′ | Strength | build-up | Dis- |
| | composition | (MPa) | (10³ N/m) | (° C.) | persibility |
| Exp. 1 | B1 | 52.7 | 68.3 | 41 | Good |
| Exp. 2 | B2 | 53.3 | 67.7 | 40 | Good |
| Comp. | B3 | 42.6 | 68.2 | 43 | Good |
| Exp. 1 | | | | | |
| Comp. | B4 | 44.6 | 67.5 | 42 | Good |
| Exp. 2 | | | | | |
| Comp. | B5 | 42.4 | 62.4 | 42 | Good |
| Exp. 3 | | | | | |
| Comp. | B6 | 43.9 | 61.8 | 43 | Good |
| Exp. 4 | | | | | |
| Comp. | B7 | 52.7 | 66.2 | 45 | Bad |
| Exp. 5 | | | | | |
| Comp. | B8 | 53.2 | 64.2 | 45 | Bad |
| Exp. 6 | | | | | |

### Example 3

A rubber composition for coating a steel cord is obtained by blending hydrous silica into the rubber composition for coating a steel cord obtained in Example 1.

### Example 4

A belt is obtained by coating steel cords plated with brass with the rubber composition for coating a steel cord obtained in Example 1. An unvulcanized tire is molded using the obtained belt according to a conventional process and the unvulcanized tire obtained is heated and pressurized in a vulcanizer to obtain a tire.

### INDUSTRIAL APPLICABILITY

A belt containing a steel cord having a good dynamic modulus of elasticity, good tear strength, good dispersibility in the rubber and low heat build-up can be obtained by using the rubber composition for coating a steel cord of the present invention.

1. A rubber composition for coating a steel cord comprising:
(A) 100 parts by weight of a rubber component mainly containing at least one rubber selected from the group consisting of natural rubbers, styrene-butadiene copolymerized rubbers and butadiene rubbers,
(B) 0.5 to 3 parts by weight of a condensation composition containing a condensation product of resorcin and acetone, which contains 40 to 80% by weight of 2,2,4-trimethyl-2′,4′,7′-trihydroxyflavan and 0 to 0.2% by weight of an acid or an alkali metal salt thereof per the total weight of the condensation composition,
(C) 0.1 to 0.4 part by weight of an organic cobalt compound in terms of cobalt content, and
(D) 0.5 to 2 parts by weight of a methoxylated methylolmelamine resin.

2. The rubber composition for coating a steel cord according to claim 1, which further contains a vulcanization accelerator.

3. The rubber composition for coating a steel cord according to claim 2, wherein the vulcanization accelerator is N,N-dicyclohexyl-2-benzothiazolesulfenamide.

4. The rubber composition for coating a steel cord according to any of claims 1 to 3, which does not contain N-cyclohexyl-2-benzothiazolesulfenamide.

5. The rubber composition for coating a steel cord according to claim 1, which does not contain hexamethylenetetramine.

6. The rubber composition for coating a steel cord according to claim 1, which further contains 45 to 60 parts by weight of carbon black per 100 parts by weight of the rubber component (A).

7. The rubber composition for coating a steel cord according to claim 1, which further contains 5 to 15 parts by weight of hydrous silica per 100 parts by weight of the rubber component (A).

8. A belt comprising a steel cord coated with the rubber composition for coating a steel cord according to claim 1.

9. A pneumatic tire produced by using the rubber composition for coating a steel cord according to claim 1.

10. Use of the rubber composition for coating a steel cord according to claim 1 for producing a steel cord coated with a rubber composition.

11. A process for producing a belt comprising a steel cord coated with a rubber composition which comprises coating a steel cord with the rubber composition for coating a steel cord according to claim 1.

12. Use of the rubber composition for coating a steel cord according to claim 1 for producing a pneumatic tire.
